(19) United States
(12) Patent Application Publication
(10) Pub. No.: US 2017/0158573 A1
(43) Pub. Date: Jun. 8, 2017

(54) TUNABLE METHOD AND SYSTEM FOR PRODUCING NUTRIENT-RICH MATERIAL FROM ORGANIC MATERIAL

(71) Applicant: reNature, Inc., Tempe, AZ (US)

(72) Inventor: Evan Taylor, Phoenix, AZ (US)

(21) Appl. No.: 15/323,721

(22) PCT Filed: Jul. 1, 2015
(86) PCT No.: PCT/US15/38905

§ 371 Date: Jan. 3, 2017

Related U.S. Application Data
(60) Provisional application No. 62/020,952, filed on Jul. 3, 2014.

(51) Int. Cl. C05F 17/00

(52) U.S. Cl. CPC C05F 17/0072; C05F 17/0027

(57) ABSTRACT

A tunable method and system for treating organic material to form nutrient-rich products are disclosed. Exemplary methods and systems include determining and/or selecting from where and/or when to pick up organic material for processing. Other exemplary methods and systems include providing soil amendments that can be tuned based on organic material to be treated and/or a desired product composition.

### CROSS-REFERENCE TO RELATED APPLICATIONS

This application claims the benefit of U.S. Provisional Patent Application Ser. No. 62/020,952, entitled LOGISTICAL METHOD AND SYSTEM FOR PRODUCING NUTRIENT-RICH MATERIAL FROM ORGANIC MATERIAL, and filed Jul. 3, 2014, the contents of which are hereby incorporated herein by reference to the extent such contents do not conflict with the present disclosure.

### FIELD OF DISCLOSURE

The present disclosure generally relates to methods and systems for treating organic material. More particularly, the disclosure relates to tunable methods and systems for collecting organic material, treating organic material, and/or providing enriched products.

### BACKGROUND OF THE DISCLOSURE

Organic material, such as organic waste (e.g., food waste, yard waste, and the like) often ends up in landfills, where it generally adds no value, and potentially produces undesirable products, such as methane gas. To mitigate production of undesirable products in landfills, some communities have instituted procedures for separating organic waste material and composting the organic waste material to form enriched products, such as soil amendments. For example, individuals may compost their own waste or the waste may be collected and processed by a waste collection organization. Although these procedures can work relatively well in some cases, composting requires a relatively large amount of space for the material to be composted, composting is relatively slow and inefficient, composting produces product with relatively low concentrations (typically less than one percent) of desired compounds and thus requires relatively high transportation costs, and composting can result in undesirable odors, particularly when meat or dairy products are being composted. In addition, such techniques cannot generally be tailored to treat specific organic waste and/or produce desired amendments. Rather, such procedures generally rely on the waste materials that are available for composting and procedures in place to treat such waste.

Accordingly, improved methods and systems are desired for forming enriched products, such as soil amendments, which can be tailored, based on the waste to be treated and/or the desired amendments.

### SUMMARY OF THE DISCLOSURE

Various embodiments of the present disclosure relate to systems and methods for collecting organic waste, treating organic waste, and/or providing enriched products. While the ways in which various embodiments of the present disclosure address drawbacks of prior techniques for waste treatment, in general, various embodiments of the disclosure provide improved methods and systems for determining and/or selecting from where and/or when to pick up organic material and/or products from a biodigestion reactor. Additionally or alternatively, exemplary embodiments provide tunable methods and systems for providing soil amendments that can be tuned or tailored based on material to be treated and/or a desired composition of an enriched product.

In accordance with exemplary embodiments of the disclosure, methods and systems use various criteria to determine what organic material or products to use in a biodigestion reactor. In accordance with various aspects of these embodiments, a method of producing nutrient-rich material from organic material includes the steps of: providing a first biodigestion reactor for reacting one or more microorganisms with organic material to form one or more nutrient-rich products, determining a desired concentration of one or more nutrients, determining a concentration of the one or more nutrients in the first biodigestion reactor using one or more first reactor sensors, determining available organic materials (e.g., organic food waste and/or material from one or more other biodigestion reactors), and based on the desired concentration of one or more nutrients and/or the concentration of the one or more nutrients in the biodigestion reactor, selecting one or more of the available organic materials for feed to the biodigestion reactor. The step of selecting one or more available organic materials can be based on, for example distance to a source of the organic materials, types of organic materials, amount of time the organic materials have been available, time since the last pickup of organic materials from a location, and the like. The one or more available organic materials may be fully or partially digested material—e.g., material digested using a biodigestion reactor as described herein—or relatively fresh, such as relatively fresh food waste or other organic material. In accordance with alternative embodiments, the first biodigestion reactor is mobile. The step of determining a desired concentration of one or more nutrients can be based on consumer demand for certain products or amendments. Exemplary methods allow for tuning an output of one or more bioreactors to produce various nutrients, such as, soil amendments, including agricultural nutrients (e.g., macro, such as N, P, K, and other such nutrients, or micro), acidic or alkaline products, inoculants, or other nutrients, such as humic acid, fulvic acid, enzymes, or the like, and concentrations thereof. For example, the nutrients can include one or more of: B, Ca, Cu, Fe, Mn, Mg, Mo, N, P, K, Na, Zn, one or more chlorides, one or more sulfates, one or more nitrates, one or more nitrites, one or more carbonates, fulvic acid, and humic acid, and the like and nutrient-rich compositions can include any combination of such nutrients. In accordance with further exemplary aspects, digestion from one or more biodigestion reactors is incomplete, such that digestion continues in another biodigestion reactor and/or after application of the nutrient-rich products to soil or other growth medium.

In accordance with further exemplary embodiments of the disclosure, methods and systems can access multiple biodigestion reactors and mix products from multiple biodigestion reactors and/or organic material sources in, e.g., a biodigestion reactor or other container (either of which can be mobile), to obtain desired products, including nutrients, such as soil amendments, including agricultural nutrients, pH adjusters, inoculants, acids, enzymes, and others. In accordance with various examples of these embodiments, a method of producing nutrient-rich material from organic material includes the steps of: providing a plurality of biodigestion reactor systems, each of the plurality of biodigestion reactor systems comprising a first biodigestion reactor for reacting one or more microorganisms with organic material to form one or more nutrient-rich products and one or more first reactor sensors to indicate a stage of biodigestion and/or concentrations or amounts of nutrients within a portion of the first biodigestion reactor; determining a stage of biodigestion and/or concentrations or amounts of nutrients within a portion of the first biodigestion reactor; determining an amount and/or type of organic material in one or more of the plurality of biodigestion reactor systems; and based on one or more of the stage of biodigestion, concentrations or amounts of nutrients, and the amount of organic material in the plurality of biodigestion reactor systems, collecting product from one or more of the plurality of biodigestion reactor systems. The method can include additionally adding organic material from one or more organic material sources. Whether and which biodigestion reactors and/or organic material sources from which to pick up material can be based on, for example, a distance to one or more of the biodigestion reactors, mileage of a pickup vehicle, an amount of material in one or more of the biodigestion reactors, desired products, route time, rout distance, fuel or travel cost, product mass and/or volume, customer demand for products, a stage of biodigestion in the one or more biodigestion reactors, enriched nutrients within the one or more biodigestion reactors, composition of the organic material, available biodigestion reactors or containers, and the like.

### BRIEF DESCRIPTION OF THE DRAWING FIGURES

A more complete understanding of exemplary embodiments of the present disclosure can be derived by referring to the detailed description and claims when considered in connection with the following illustrative figures.

FIG. 1 illustrates a tunable system for producing nutrient-rich material from organic material in accordance with exemplary embodiments of the disclosure.

FIG. 2 illustrates a method for producing nutrient-rich material from organic material in accordance with additional exemplary embodiments of the disclosure.

FIG. 3 illustrates a tunable system for producing nutrient-rich material from organic material in accordance with yet further exemplary embodiments of the disclosure.

FIG. 4 illustrates a method for producing nutrient-rich material from organic material in accordance with yet additional exemplary embodiments of the disclosure.

FIG. 5 illustrates a biodigestion reactor system suitable for exemplary methods and systems of the present disclosure.

FIGS. 6 and 7 illustrate additional tunable systems in accordance with exemplary embodiments of the disclosure.

It will be appreciated that elements in the figures are illustrated for simplicity and clarity and have not necessarily been drawn to scale. For example, the dimensions of some of the elements in the figures may be exaggerated relative to other elements to help to improve the understanding of illustrated embodiments of the present disclosure.

### DETAILED DESCRIPTION OF EXEMPLARY EMBODIMENTS OF THE DISCLOSURE

The description of exemplary embodiments provided below is merely exemplary and is intended for purposes of illustration only; the following description is not intended to limit the scope of the disclosure or the claims. Moreover, recitation of multiple embodiments having stated features is not intended to exclude other embodiments having additional features or other embodiments incorporating different combinations of the stated features.

As set forth in more detail below, exemplary methods and systems as described herein relate to tunable methods and systems to convert organic material into enriched products that can be used to provide nutrients to a growth medium. The systems and methods can produce fine-tuned products based on customer demands, available organic material, and the like.

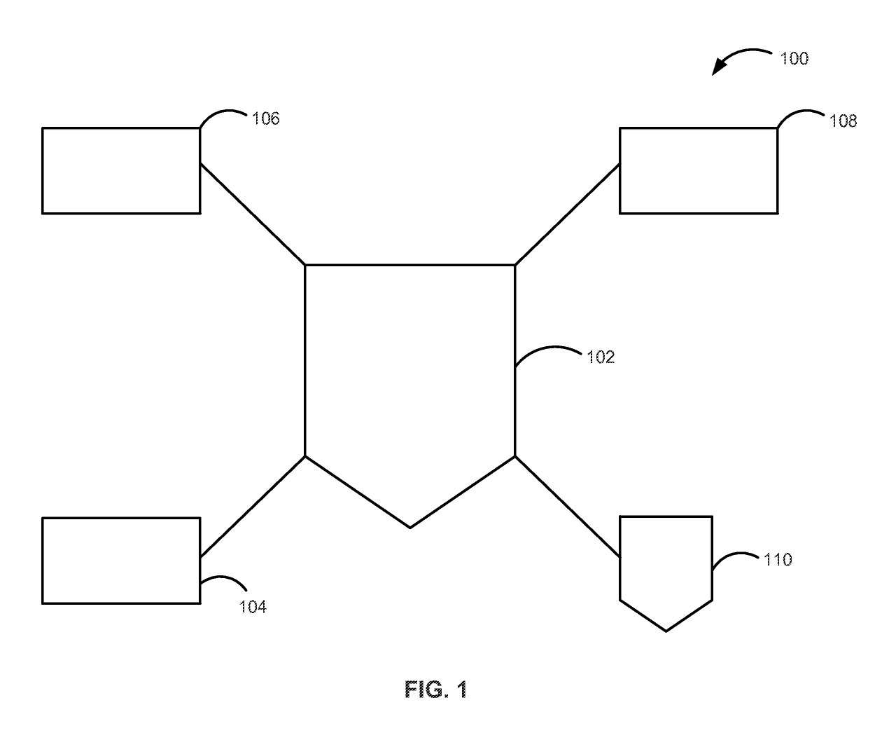

FIG. 1 illustrates an exemplary tunable system 100. In the illustrated example, tunable system 100 includes one or more biodigestion reactors systems 102, one or more organic material sources 104-108, and an (optional) additional biodigestion reactor system 110.

During operation of tunable system 100, material is transported from one or more organic material sources 104-108, and optionally additional biodigestion reactor system 110, to biodigestion reactor system 102 for treatment. Products from biodigestion reactor system 102 can be fine-tuned based on, for example, selecting types of organic material available from one or more organic material sources 104-108 and/or from other biodigestion reactors systems 110.

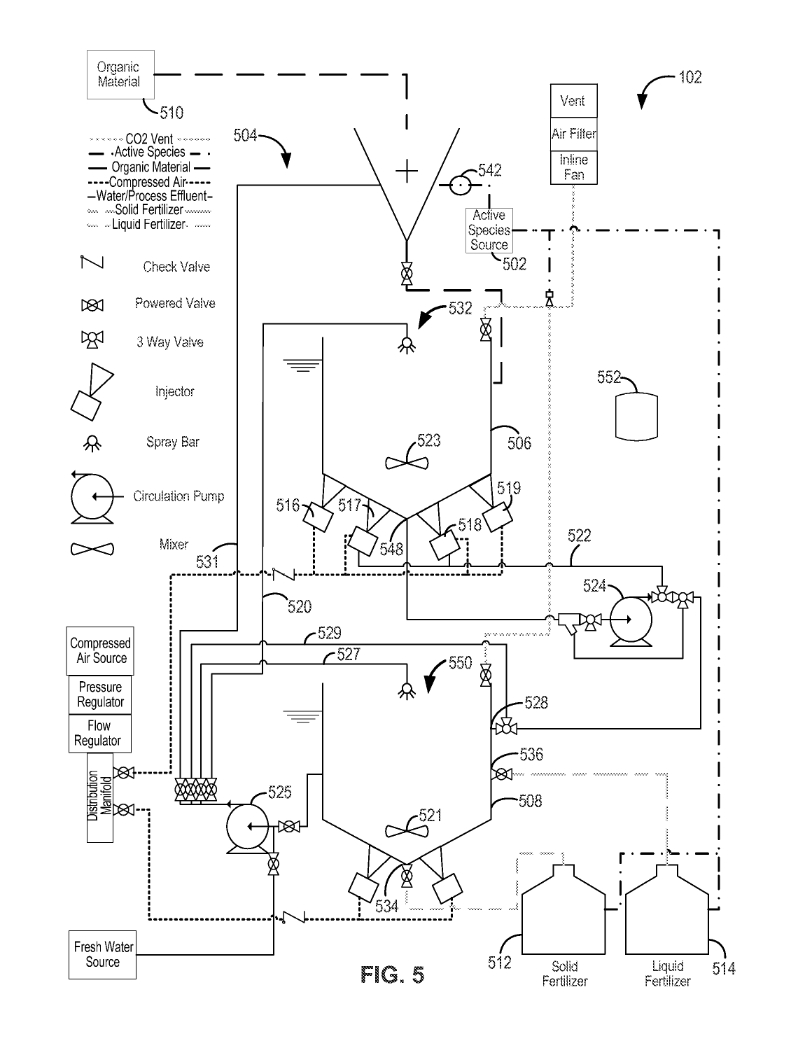

Biodigestion reactor system 102 and/or 110 can include one or more biodigestion reactors that use one or more microorganisms to form desired products from organic material. An exemplary biodigestion reactor system 102 is illustrated in FIG. 5. In the illustrated example, biodigestion reactor system 102 includes an active species source 502 and a biodigestion reactor apparatus 504. Biodigestion reactor apparatus 504 can include multiple reactors or stages. In the illustrated example, biodigestion reactor apparatus 504 includes a first biodigestion reactor 506 and a second biodigestion reactor 508. Biodigestion reactor systems can include any suitable number of reactors or stages, which may be in series and/or in parallel. By way of examples, tunable system 100 can include 1, 2, 3, 4, 5, 6, 7, 8, 9, 10, or more first and/or second biodigestion reactors, wherein each of the first and/or second biodigestion reactors can be coupled in series or in parallel.

During operation of system 102, organic material, which may be supplied from one or more sources 104-108, source 510, and/or other reactor system 110, is digested using one or more microorganisms to form enriched products, that include one or more nutrients, such as soil amendments, including one or more agricultural nutrients, pH adjusters, inoculants, or other amendments, such as humic acid, fulvic acid, enzymes, various bacterial, enzymes, and the like. The organic material—e.g., organic material from one or more sources 104-108, 110, and/or 510 can be treated with active species (e.g., an oxidant, such as ozone) from active species source 502. Treated organic material and/or untreated organic material is then transferred to first biodigestion reactor 506 (e.g., at a first input 532) for treatment, and, in the illustrated example, to second biodigestion reactor 508 for further treatment. Enriched products can be collected in vessels 512 (for, e.g., solids) and 514 (for, e.g., liquids).

Organic material from any of sources 104-108, 510 can include, for example, one or more materials from the group consisting of food waste, paper, cardboard, animal waste, and other biodegradable organic material. By way of particular examples, the organic material includes food waste, which may include meat, dairy, and/or vegetation.

Active species source 502 can include any suitable source of active species. By way of examples, active species source 502 includes an oxidant source. The oxidant source can be an ozone generator. Exemplary ozone generators suitable for use with the present disclosure include coronal discharge ozone generators and ultraviolet light ozone generators. Exemplary ozone generators can operate at or near atmospheric pressure. The exemplary generators can produce, for example, greater than 100 ppb ozone in air, greater than 500 ppb ozone in air, greater than 1 ppm ozone in air, or greater than 2 ppm ozone in air. In accordance with various aspects of these examples, ozone can be generated by drawing (e.g., via a pump) air though a reaction chamber of an active species source, and energizing the oxygen atoms—for example, by using ultraviolet light or a coronal discharge—to increase a concentration of active species in air. For example, a concentration of ozone can increase from about 10 ppb to greater than 100 ppb ozone in air, greater than 500 ppb ozone in air, greater than 1 ppm ozone in air, or greater than 2 ppm ozone in air. The air with increased active species (e.g., ozone) can then be pumped toward organic material 110 to treat the organic material.

The active species can be used to reduce odors that might otherwise be associated with organic material 510, to sterilize organic material 510, to break down organic material 510, to increase a surface area to volume ratio of organic material, to kill microorganisms on a surface of organic material 510, to reduce a number of microorganisms on the surface, to break down toxins, such as herbicides and pesticides, to breakdown pharmaceuticals, and/or break down volatile organic compounds in or associated with the organic material. Reducing the number of microorganisms has an added benefit of providing additional process control during processing of organic material 510 in, for example, reactors 506 and 508 of biodigestion system 504. And, the active species can be used to reduce or eliminate pathogenic microorganisms, such as E. coli on a surface of organic material 510.

Biodigestion reactor system 102 can be configured, such that a half-life of the active species is relatively short, such that the active species do not undesirably interfere with downstream processes. For example, the half-life of the active species can be less than 2 hours, less than 1.5 hours, less than 1 hour, about 30 minutes or less, or be about 30 to about 60 minutes.

Biodigestion reactors 506, 508 can include any suitable biodigestion reactor. By way of examples, biodigestion reactor 506 can include a first vessel 544 formed of metal, such as stainless steel or plastic, such as high-density polyethylene (HDPE). Biodigestion reactor 508 can similarly include a second vessel 546 formed of metal, such as stainless steel or plastic, such as HDPE. Reactors 506, 508 can include one or more microorganisms, such as one or more inoculants, such as bacteria and/or fungi to break down the organic material into one or more products, solvents, such as water, pH adjusters, pH buffers, and the like. Biodigestion in biodigestion reactors 506, 508 can include aerobic digestion of the organic material. For example, the biodigestion in reactors 506, 508 can be greater than 80% aerobic digestion, greater than 90% aerobic digestion, or greater than 95% aerobic digestion.

Exemplary microorganisms suitable for use with the present disclosure, exemplary growth temperatures, and exemplary pH ranges are provided below in Table 1.

TABLE 1

| | | Exemplary Temperature Range | | Exemplary |
|---|---|---|---|---|
| Microbe | Exemplary Use | Min ° C. | Max ° C. | pH |
| Azobacter | Atmospheric Nitrogen | 25 | 30 | 7.25 |
| chroococcum | fixing | | | |
| Bacillus | Starch Hydrolysis and | 30 | 40 | 6.3 |
| amyloliquefaciens | Enzymatic Protein | | | |
| | Digestion | | | |
| Bacillus | Denitrifying | 42 | 46 | 7 |
| azotoformans | | | | |
| Bacillus coagulans | Lactic Acid production | 40 | 50 | 7 |
| Bacillus | Controllable for discrete | 37 | 50 | 6.8 |
| licheniformis | enzyme production at | | | |
| | specific temperature and | | | |
| | pH ranges. Protease | | | |
| | (protein digestion) at | | | |
| | high temperature | | | |
| Bacillus megaterium | Atmospheric Nitrogen | 30 | 42 | 7 |
| | fixing | | | |
| Bacillus pumilus | Atmospheric Nitrogen | 37 | 50 | 6.5 |
| | fixing | | | |
| Bacillus subtilis | Many beneficial | 25 | 35 | 7 |
| | digestion enzymes such | | | |
| | as amylase, protease, | | | |
| | pullulanase, chitinase, | | | |
| | xylanase, lipase, among | | | |
| | others | | | |
| Bacillus | Natural Insecticide as a | 50 | 70 | 7 |
| thuringiensis | result of digestion | | | |
| Paenibacillus durum | Beneficial Soil Microbe | 40 | 50 | 7 |
| | for Crops | | | |
| Paenibacillus | Beneficial Soil Microbe | 30 | 50 | 8 |
| polymyxa | for Crops | | | |
| Pseudomonas | Lipase production | 30 | 35 | 7.2 |
| aureofaciens | | | | |
| Pseudomonas | Kills pathogens, digests | 28 | 30 | 7 |
| fluorescens | lignin | | | |
| Streptomyces | Produces geosmin, a | 25 | 35 | 6.25 |
| griseues | humic acid, and pleasant | | | |
| | ″earthy odors″ | | | |
| Streptomyces | Improves yields in some | 30 | 40 | 5.8 |
| lydicus | legumes and peas | | | |
| Actinobacteria | Higher Temperature | 40 | 48 | 7 |
| thermomonospora | lignin digestion | | | |
| Actinobacteria | Kills pathogens, digests | 33 | 45 | 7 |
| actinomadura | lignin | | | |
| Actinobacteria | Digests Lignin | 33 | 35 | 7 |
| actinosynnema | | | | |
| Actinobacteria | Digests Lignin and can | 33 | 35 | 7 |
| nocardiopsis | survive in high salt- | | | |
| | content environments | | | |
| | (e.g., soy product waste) | | | |
| Actinobacteria | Breaks down lipids | 33 | 35 | 7 |
| streptoalloteichus | | | | |
| Azospirillum | Colonizes roots to | 25 | 30 | 7 |
| Lipoferum | promote plant growth | | | |
| Aquaspirillum | Can survive in high salt- | 30 | 32 | 7 |
| magnetotacticum | content environments | | | |
| | (e.g., soy product waste) | | | |
| Cellvibrio mixtus | Cellulose digestion and | 65 | 70 | 7 |
| | high temperature allow | | | |
| | for creative use in | | | |
| | primary reactors to | | | |
| | control for contaminant | | | |
| | bacteria or secondary | | | |
| | reactors to digest the | | | |
| | remaining | | | |
| | lignin/cellulose | | | |
| Herbaspirillum | Promotes rice growth, | 25 | 34 | 7 |
| seropedicae | | | | |
| Marinomonas | Can survive in high salt- | 20 | 40 | 7 |
| primoryensis | content environments | | | |
| | (e.g., soy product waste) | | | |
| Acidothermus | Breaks down lignin and | 50 | 60 | 6 |
| cellulolyticus | cellulose into many | | | |
| | useful acids for other | | | |
| | bacteria or plant | | | |
| | digestion | | | |
| Agromonas | Nitrogen Fixing at low | 25 | 27 | 7 |
| oligotrophica | temperatures | | | |
| Azomonas agilis | Nitrogen Fixing at low | 20 | 30 | 7.4 |
| | temperatures | | | |
| Azorhizobium | Symbiotic with plant | 25 | 30 | 7 |
| caulinodans | roots and stems | | | |
| Beijerinckia | Breaks down oils | 20 | 30 | 9.5 |
| Bradyrhizobium | Nitrogen fixing and | 25 | 30 | 7 |
| japonicum | symbiotic with plants | | | |
| Derxia gummosa | Symbiotic with plants for | 25 | 35 | 5.5 |
| | tropical soils and | | | |
| | nitrogen fixing | | | |
| Janthinobacterium | Produces anti-fungal | 25 | | 7 |
| lividum | agents for promoting | | | |
| | plant health | | | |
| Rhizobium | Soybean symbiosis and | 27.4 | 33.7 | 6.6 |
| japonicum | nitrogen fixation | | | |
| Sinorhizobium | Reduction of N2 to NH4 | 25 | 30 | 7 |

Biodigestion reactors 506, 508 can also include one or more agitators or mixers to circulate material within the reactors. For example, biodigestion reactor 506 can include one or more venturi injectors 515, 516, 517, 518 to mix material within biodigestion reactor 506. Alternatively, pumps or impellers could be used as the agitators. Use of a venturi injector (e.g., an eductor) may be particularly advantageous, because, in addition to mixing the material, the venturi injector can be used to add air, e.g., at a known or controlled flow rate, to the reactor, which can facilitate aerobic digestion. In addition, using a venturi injector can be advantageous because it can cause material to move and mix that might otherwise be difficult to move or mix with a traditional agitator. Also, use of a venturi injector 515-518 can be used to regulate or assist with regulation of a temperature in a reactor. Biodigestion reactors 506, 508 can additionally or alternatively include other agitators, such as a motor-driven impellers 519, 521.

As noted above, first biodigestion reactor 506 and/or second biodigestion reactor 508 can be configured to accommodate one or more types of organic material (e.g., food waste and/or particular types of food waste, such as vegetation, dairy, meat, etc., paper, cardboard, animal waste, and other biodegradable organic material). For example, system 102 can include one first biodigestion reactor 506 that is configured to digest a plurality of types of organic material. Or, system 102 can include two or more first biodigestion reactors, wherein one or more of the first biodigestion reactors are configured to digest particular types of organic material. For example, the first biodigestion reactors can run at particular temperatures, pH levels, and/or include particular microorganisms that favor the breakdown of the organic material (e.g., meat, dairy, and/or vegetation) feed into one or more nutrient-rich products. The output from the plurality of first biodigestion reactors 506 can be fed to one or more second biodigestion reactors 508. Each biodigestion reactor 506, 508 can be sized to accommodate an amount material to be processed.

One or more of biodigestion reactors 506, 508 can include a filter between a reactor input (e.g., input 532) and an output (e.g., first output 548 of first reactor 506). Additionally or alternatively, system 102 can include filters between input 550 and second output 534 and/or third output 536 of second biodigestion reactor 508. An exemplary filter can include a mesh, having opening with an average cross sectional size of about 3 mm to about 4 mm. The filter can advantageously be removable to allow for cleaning and maintenance. Additionally or alternatively, one or more of first biodigestion reactor 506 and second biodigestion reactor 508 can include a screen (or mesh) and/or a cage. Additionally or alternatively, biodigestion reactors can include one or more membranes that retain bacteria and/or enzymes, and allow nutrient-rich product to pass through the membrane. Such membranes may be particularly useful in a second biodigestion reactor.

Biodigestion reactors 506, 508 can be configured for different types of reactions. For example, first biodigestion reactor 506 can be configured to provide relatively high microorganism growth rate. By way of examples, first biodigestion reactor 506 can operate at a temperature of about 60° C. to about 72° C. or about 25° C. to about 55° C. or about 30° C. to about 40° C. The pH of first biodigestion reactor can range from about 4.8-9 or about 5-8. The temperature can also be controlled to facilitate or discourage growth of certain microorganisms; the microorganisms can be tuned to digest certain types of material. For example, the temperature can be set at a temperature high enough to kill undesired microorganisms, such as pathogens, such as E. coli, and/or encourage growth of other microorganisms, including microorganisms that kill certain pathogens, such as E. coli and/or that can digest certain types of organic material, such as cellulose-based material. In these cases, for example, the biodigestion reactor can be run at a temperature of about 60° C. to about 72° C. to tune the microorganisms (e.g., kill unwanted pathogens) and/or to encourage growth of certain microorganisms, such as those that break down cellulose.

Second biodigestion reactor 508 can be configured to provide relatively high enzyme production from a reaction of the microorganisms and the organic material. By way of examples, second biodigestion reactor 508 can operate at a temperature of about 25° C. to about 55° C. or about 30° C. to about 40° C. or about 60° C. to about 72° C.—e.g., for the same reasons noted above. The pH of first biodigestion reactor can range from about 4.8-9 or about 5-8.

In accordance with some exemplary embodiments of the disclosure, one or more of a temperature, pH, and oxygen supply rate to first biodigestion reactor 506 and/or second biodigestion reactor 508 can be varied to control selectivity of microorganisms within the respective reactor. Further, a temperature of first biodigestion reactor 506 and/or second biodigestion reactor 508 can be manipulated during processing to, for example, initially favor higher digestion rates (e.g., at a higher temperature) and then to control selected microorganism growth and/or increased enzyme production (e.g., at a lower temperature). Additionally or alternatively, a temperature can be manipulated to increase acid (e.g., humic acid or fulvic acid) production.

System 102 also includes one or more circulation lines 520, 522, 523, 525, 527 which can include one or more circulation pumps 524, 526. Material from second biodigestion reactor 508 (e.g., received from a first output 528 of second biodigestion reactor 508) can be provided to first biodigestion reactor 506 (e.g., a second input 530) using line 525 and pump 526. Similarly, material from second biodigestion reactor 508 can be provided to first biodigestion reactor 506 using line 520 and pump 524. Material circulated from second biodigestion reactor 508 to first biodigestion reactor 506 can be used to control reactions and reaction rates in both first biodigestion reactor 506 and second biodigestion reactor 508. Controlling the reactions in the respective biodigestion reactors can, in turn, allow control of products and nutrient concentrations from biodigestion reactors system 504. Furthermore, a location of output 536 and/or input 550 can be used to control desired and/or undesired reactions within the respective biodigestion reactors. For example, an output 536 may be raised or lowered depending on desired material to be circulated to first biodigestion reactor 506. Similarly, input 532 and/or 530 can be moved to “feed” one or more regions within first biodigestion reactor 506. System 102 can also include automated or manual back flush systems on one or more of the lines to prevent, mitigate, or reverse clogging in various lines of the system to or from reactors 506, 508. In the illustrate example, line 527 can be used to provide liquid from second biodigestion reactor 508 to grinder 540 to reduce an amount of water that might otherwise be added to system 102 to facilitate grinding of organic material 510. The circulated material in line 527 can also facilitate breakdown of organic material. Although not illustrated, material from first biodigestion reactor 506 can similarly be used to treat organic material 510. Further, exemplary systems can use feedback from one or more of circulation pumps 524, 526 to manipulate one or more process parameters (e.g., dilution of material within the reactor (e.g., dilute material in reactor 506 with material from reactor 508), change pump speed, or the like) of first biodigestion reactor 506 and/or second biodigestion reactor 508.

System 102 can also include gas circulation lines 554 to allow for gas produced from one reactor to be introduced into another reactor. For example, NH₃, CO₂, NOₓ, or the like can be fed from biodigestion reactor 506 to biodigestion reactor 508 or vice versa or to a final product in vessel 512 or 514. Additionally or alternatively, gas output from a first biodigestion reactor can be fed to another first biodigestion reactor and/or from a second biodigestion reactor to another second biodigestion reactor. Feeding gasses from one reactor to another can be used to control nutrient content, a pH within a reactor, and/or promote or inhibit growth of particular microorganisms, and/or promote digestion of organic material.

As noted above, nutrient-enriched products can be collected in vessels 512, 514. For example, (e.g., solid) products from a second output 534 of second biodigestion reactor 508 can be collected in vessel 512. And, (e.g., liquid) products can be collected in vessel 514 from a third output 536 of second biodigestion reactor 508. A composition and/or concentration of the products can be based on a location of the second and/or third outputs. The active species source 502 can be used to treat one or more products in vessels 512, 514 and/or material between biodigestion reactors in, for example, line 556. For example, if it is desired to stop or mitigate growth of one or more microorganisms in the product(s), the active species source can be used to reduce a number of microorganisms in the product(s). Additionally or alternatively, the product(s) can be subjected to a pasteurization process.

The liquid and solid products can include nutrients that can be used as soil amendments. Various nutrients include biologically available nutrients, such as one or more of B, Ca, Cu, Fe, Mn, Mg, Mo, N, P, K, Na, Zn, one or more chlorides, one or more sulfates, one or more nitrates, one or more nitrites, one or more carbonates, fulvic acid, humic acid, and enzymes.

System 102 can also include a hopper 538 to hold organic material. System 102 can also include a grinder 540 to cut organic material into smaller pieces. Use of grinder 540 can increase a surface area of organic material available for reaction in biodigestion apparatus 504.

System 102 can also include an evaporator (not illustrated) coupled to one or more outputs of a biodigestion reactor, such as second biodigestion reactor 508.

Exemplary systems, such as system 102, can also include one or more sensors. For example, system 102 can include an active species sensor 542. Active species sensor 542 can be located anywhere between active species source 502 and first input 532.

System 102 can include one or more of a temperature sensor, a pH sensor, an ethanol sensor, an H₂S sensor, an NH₃ sensor, a dissolved O₂ sensor, a weight sensor, and a CH₄ sensor, a nitrite sensor, a CO₂ sensor, a temperature sensor, an NOₓ sensor, a humidity sensor, and a pressure sensor coupled to one or more of the first biodigestion reactor 506 and the second biodigestion reactor 508. The sensors can be used to monitor reactions within the respective biodigestion reactors and one or more process parameters, such as mixing rate, circulation rate, amount of microorganisms, types and species of microorganisms, and the like, and can be manipulated based on sensor values. Furthermore, one or more sensors and/or sensor types can be located at various locations (e.g., heights) of the first biodigestion reactor vessel 544 and/or second biodigestion reactor vessel 546 to monitor various reactions at the respective locations of the biodigestion reactors.

As shown in FIG. 5, system 102 can also include one or more breeder reactors 552. Breeder reactor(s) 552 can be used to incubate or grow one or more microorganisms for use in one or more of first biodigestion reactor 506 and second biodigestion reactor 508. Breeder reactor(s) 552 can include suitable nutrient(s), water, and/or air supplies.

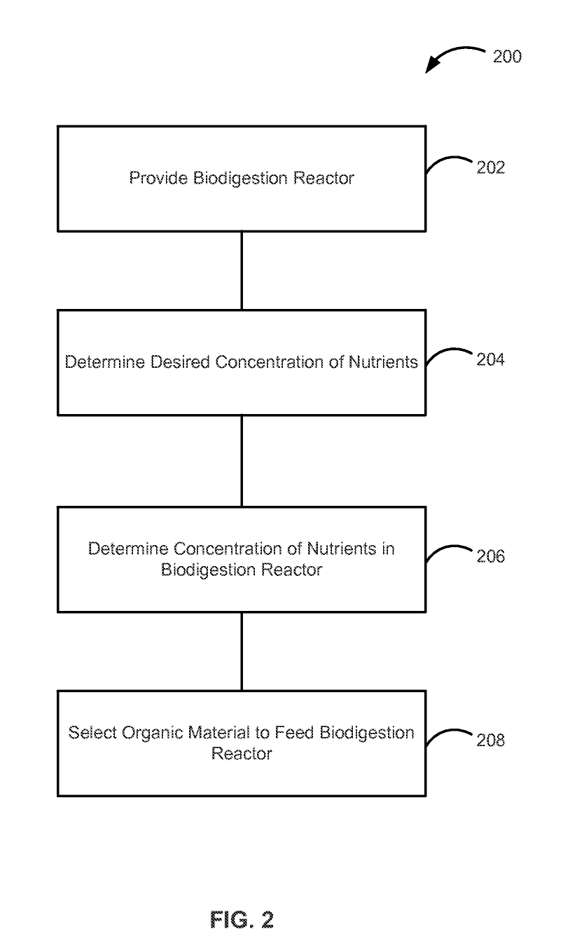

Turning again to FIG. 2, a method 200 of producing nutrient-rich material from organic material is illustrated. Method 200 includes the steps of providing a first biodigestion reactor (step 202), determining a desired concentration of one or more nutrients (step 204), determining a concentration of the one or more nutrients in the first biodigestion reactor (step 206), and selecting one or more of the available organic materials for feed to the biodigestion reactor (step 208). As set forth in more detail below, some or all of the steps of method 200 can be implemented using a computer system.

Step 202 can include providing a first biodigestion reactor, such as reactor 506 of system 102, for reacting one or more microorganisms with organic material to form one or more nutrient-rich products.

During step 204, a desired concentration of one or more nutrients is determined. The concentration can be based on, for example, particular customer demands, minimum or lower operating cost targets, or the like.

Step 206 includes determining a concentration of the one or more nutrients in the first biodigestion reactor. The concentration(s) can be determined using one or more first reactor sensors, measuring the concentration using analytical techniques, such as color measurements, titration, color shift, pH, temperature, or the like, and/or using calculations based on an amount of time and/or types of microorganism(s) used in the biodigestion reactor. By way of example, actual concentrations can be measured or estimated using sensors, such as the sensors noted above, to determine a stage of biodigestion.

At step 208, one or more organic material sources (e.g., sources 104-108, 510) can be selected to provide feed to the first biodigestion reactor. Additionally or alternatively, material from another biodigestion reactor system 110 can be provided as feed to the first biodigestion reactor.

Method 200 can also include steps of providing a second biodigestion reactor fluidly coupled to the first biodigestion reactor and determining a concentration of the one or more nutrients in the second biodigestion reactor using one or more second reactor sensors, measuring the concentration using analytical techniques, such as those described above, and/or using calculations based on an amount of time and/or types of microorganism(s) used in the biodigestion reactor.

Method 200 can include a step of sorting the organic material. For example, food waste can be separated from other organic material, and the food waste can optionally be further separated by, for example, primarily (e.g., greater than 50%, 60%, 75%, 80%, 90%, or 95%) meat or vegetation.

In accordance with various aspects of these embodiments, method 200 includes a step of estimating a delivery time and/or distance for organic material from one or more organic material sources, such as sources 104-108, to reactor system 102. The time and/or distance estimates for delivery can be used as a factor to determine which source of organic material to use as a feed for system 102, and can be calculated using a computer implemented system.

Method 200 can additionally or alternatively include one or more of a step of monitoring an aerobic biodigestion reaction—e.g., to ensure that a desired amount of aerobic digestion is taking place, sterilizing one or more reactors or vessels, adding organic and/or partially digested material to the reactor system, and emptying a vessel—e.g., based on the step of monitoring. The monitoring can be performed using one or more wired or wireless sensors as described herein.

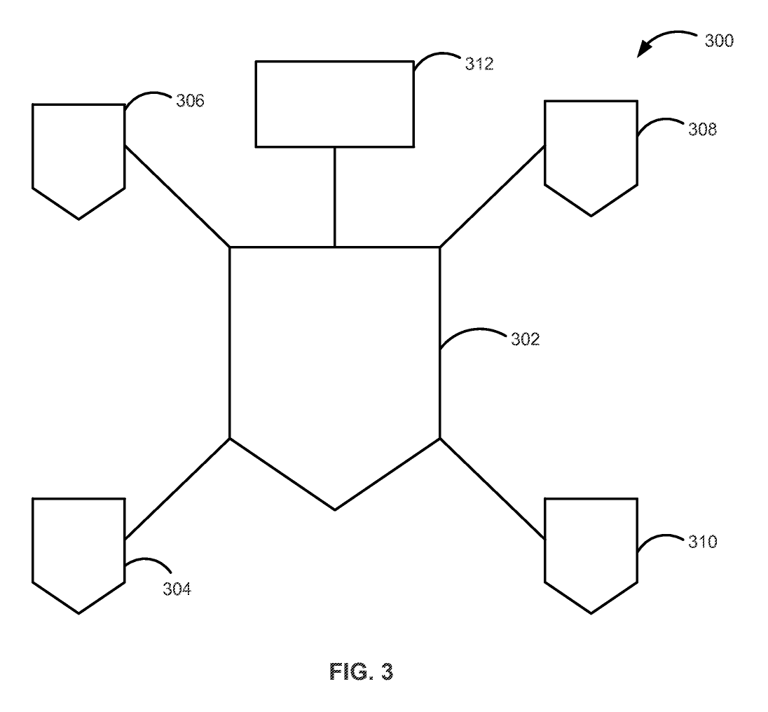

FIG. 3 illustrates another system 300 in accordance with additional embodiments of the disclosure. System 300 includes biodigestion reactor system 302, additional biodigestion reactor systems 304-310, and optional organic material source 312.

In the illustrated example, output from one or more biodigestion reactor systems 304-310 is fed to biodigestion reactor system 302 for further processing. Although illustrated with four additional biodigestion reactor systems, one or more additional biodigestion reactor systems can be used. In accordance with an alternative embodiment, biodigestion reactor system 302 can be replaced with one or more mixing tanks, which can be stationary or mobile.

Reactor system 302 and additional biodigestion reactor systems 304-310 can be the same or similar to reactor system 102. Similarly, organic material source 312 can be the same or similar to any of organic material sources 104-108.

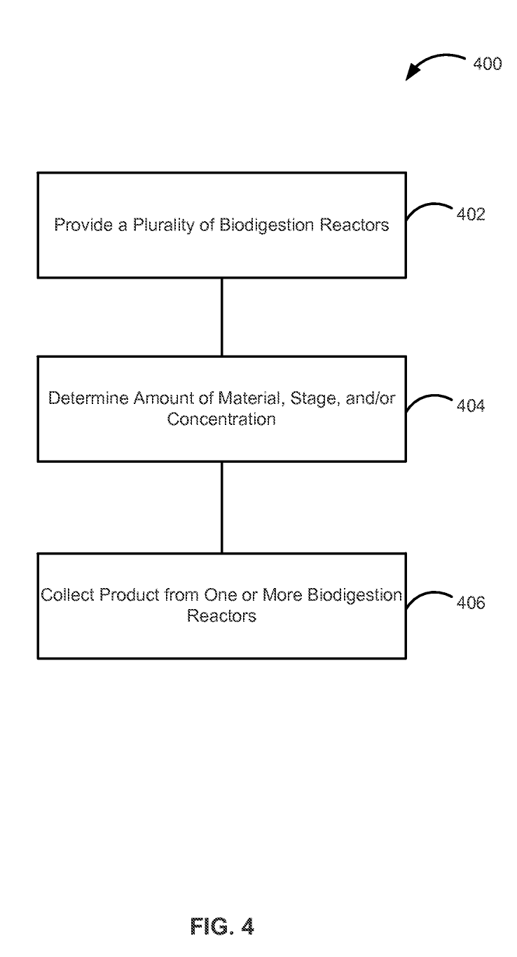

FIG. 4 illustrates a method 400 of producing nutrient-rich material from organic material in accordance with yet further exemplary embodiments of the disclosure. Method 400 includes the steps of providing a plurality of biodigestion reactor systems (step 402), determining one or more of an amount of organic material in the one or more of the plurality of biodigestion reactor systems, a stage of biodigestion in the one or more of the plurality of biodigestion reactor systems, and a concentration of nutrients in in the one or more of the plurality of biodigestion reactor systems (step 404), and collecting product from one or more of the plurality of biodigestion reactor systems (step 408). Method 400 can be used to obtain and provide nutrient-rich product with desired nutrients and/or nutrient concentrations. For example, method 400 can be used to tune the composition to product having desired concentrations of humic acid, fulvic acid, pH, microbe content, other nutrients noted herein, and the like. By way of particular example, a reactor with a high concentration of nitrogen-fixing microbes could be used for waste from a corn-processing plant that produces organic material with high nitrogen content.

During step 402, a plurality of biodigestion reactor systems, such as system 302-310 are provided. Each biodigestion reactor system can be the same or similar to biodigestion reactor system 102. For example, each biodigestion reactor system can include a reactor apparatus including a first biodigestion reactor and a second biodigestion reactor. The biodigestion system can include a reactive species source. Further, one or more of the plurality of biodigestion reactors can include one or more first reactor sensors and/or second reactor sensors to provide indicia of biodigestion in the respective reactors.

At step 404, one or more of an amount of organic material in the one or more of the plurality of biodigestion reactor systems, a stage of biodigestion in the one or more of the plurality of biodigestion reactor systems, and a concentration of nutrients in in the one or more of the plurality of biodigestion reactor systems is determined. For example, one or more sensors as described herein or analytical techniques can be used to determine one or more of an amount of organic material in the one or more of the plurality of biodigestion reactor systems, a stage of biodigestion in the one or more of the plurality of biodigestion reactor systems, and a concentration of nutrients.

During step 406, a determination is made whether to collect product from one or more of the plurality of biodigestion reactor systems. The determination can be based on, for example, one or more of an amount of organic material, a stage of biodigestion, the concentration of one or more nutrients, or the like.

Method 400 can additionally include a step of determining a distance and/or time to/from each of the plurality of biodigestion reactor systems (e.g., from a biodigestion reactor system used for further processing of material), and factoring distance and/or time to retrieve products from the plurality of biodigestion reactor systems.

Pickup and routing can additionally or alternatively be based on, for example, traffic monitoring to adjust travel cost (operating cost of the time to move the vehicle) as well as partial “tuning” of liquid pickup through knowing the nutrient makeup of the effluent from each “spoke” reactor. By way of particular example, method 300 (or system 300) can pick up 500 gallons of nitrogen-rich 12-9-0 effluent from a corn-processing facility, then 250 gallons of 3-4-3 effluent from a food plant, and 250 gallons 1-5-8 effluent from a dairy plant and then be able to deliver 1000 gallons of 7-1-0.4 to a farmer. This could allow “just-in-time” delivery for major bulk customers. Alternatively, the 7-1-0.4 mixture could be brought to a hub for bottling. This could be extended to micronutrients (calcium for example) for tomato growers or for humic acids/microbe needs of customers as well. If various locations put out fairly similar nutrient effluent, microbes can be manipulated by changing, for example, temperature and/or pH levels and inoculating with slightly different microbe mixtures, letting us tune for microbes.

The formulations below can be used to determine a score, which in turn can be used when and from where to pick up material.

### Pickup Score:

$$\frac{FVA + \frac{1}{FWP} \times ASWP}{FSTC}$$

### Or:

$$\frac{ρ + \frac{1}{φ} \times ϕ}{ϱ} = Ψ$$

### Value Score:

$$\frac{\frac{FP \times FV}{FVC}}{\frac{RD}{MPG} \times FC + RT * ER}$$

### Or:

$$\frac{\frac{ω \times ξ}{ψ}}{\frac{k}{v} \times β + σ \times ϛ} = γ$$

### Spoke Capacity Score:

$$( \frac{ρ}{ϱ} ) = Φ$$

### Capacity Weighted Pickup Value Score:

$$( \frac{ρ + \frac{1}{φ} \times ϕ}{ϱ} ) ( \frac{\frac{ω \times ξ}{ψ}}{\frac{k}{v} \times β + σ \times ϛ} ) ( \frac{ρ}{ϱ} ) = ΨϒΦ = Ω$$

### List of Variables

| | Variable | | |
|---|---|---|---|
| Full Name | Letter | Variable Code | Formula/Notes |
| Miles per Gallon | ν | MPG | Vehicle Fuel Economy |
| | | | (Avg.) |
| RouteDistance | κ | RD | GPS route distance + |
| | | | Vehicle Routing Problem |
| | | | Algorithm (Can use: |
| | | | Fisher and Kaikumar, |
| | | | The Petal algorithm, The |
| | | | Sweep algorithm, or |
| | | | Taillard, etc. |
| RouteTime | σ | RT | GPS route time + |
| | | | loading time |
| FuelCost | β | FC | Current Fuel Price |
| TravelFuelCost | | TC | RD/(MPG*FC) |
| EmployeeTimeToday | ζ | ETT | Total Shift Hours |
| CurrentTime | τ | CT | Current Hour |
| EmployeeTimeAvailable | η | ETA | ETT-CT |
| EmployeeRate | [symbol] | ER | Employee Cost |
| EmployeeTimeCost | | TC | ER*RT + (VC*(RT/ETT)) |
| VehicleCost | ι | VC | Daily Operations Cost of |
| | | | the Truck (depreciation, |
| | | | leases, maintenance, |
| | | | other non-fuel/non- |
| | | | employee costs, etc.) |
| FertilizerVolumeTruck | ο | FVT | Truck Total Capacity |
| FertilizerVolumeTruckCurrent | μ | FVTC | Current Volume of |
| | | | Fertilizer in Truck |
| FertilizerVolumeAvailable | ρ | FVA | Spoke Reactor Available |
| | | | Fertilizer (Processed or |
| | | | semi-processed) |
| FertilizerVolumeReceivable | ω̅ | FVR | FVT-FVTC |
| FertilizerSpokeTotalCapacity | [symbol] | FSTC | Spoke Reactor Size |
| AnticipatedSpokeWeeklyProduction | φ | ASWP | Spoke Reactor Weekly |
| | | | Production (Estimated) |
| FertilizerWeeklyPickups | φ | FWP | Spoke Reactor Customer |
| | | | Pickup Needs (Based |
| | | | contractual requirements |
| | | | or maintaining specific |
| | | | fertilizer volume levels |
| | | | in the reactor) |
| FertilizerValue | ξ | FV | Market Price per |
| | | | Nutrient KG, and/or |
| | | | microbe solution values, |
| | | | and/or humic/fulvic acid |
| | | | values, minus cost of |
| | | | additional processing |
| | | | steps (e.g. digestion or |
| | | | bottling) |
| FertilizerValueConstant | ψ | FVC | Weighting Value to |
| | | | make sure that the |
| | | | employee time is only a |
| | | | certain % of the value of |
| | | | the pickup |
| | | | (EmployeeTimeCost |
| | | | should never go above |
| | | | 5% of the value of the |
| | | | load, so in this case the |
| | | | value might be 20 so |
| | | | 1/20 = 5%) |
| FertilizerPickup | ω | FP | Quantity to be picked up |
| | | | from a Spoke that can be |
| | | | carried by the remaining |
| | | | volume of the vehicle |
| PostPickupQuantity | δ | PPQ | Quantity remaining in |
| | | | Spoke |
| SpokeCapacityScore | Φ | SAC | FVA/FSTC |
| PickupScore | Ψ | PS | See Above |
| ValueScore | γ | VS | See Above |
| WeightedPickup/ValueScore | Ω | | See Above |

Method 400 can additionally or alternatively include a step of determining one or more of: type of one or microorganisms, a salinity, and a biomass of the one or more nutrient-rich products. Method 400 can also include a step of mixing one or more products from a first biodigestion reactor system with one or more products from a second biodigestion reactor system. As noted above, the mixing can be performed in a biodigestion reactor or in a mixing tank, which can be stationary or movable, such as a tank on a truck. An amount of product from each of the plurality of reactors systems can be based on one or more desired nutrient concentrations, time to retrieve material from the respective biodigestion reactor systems, and/or distance to the respective biodigestion reactor systems.

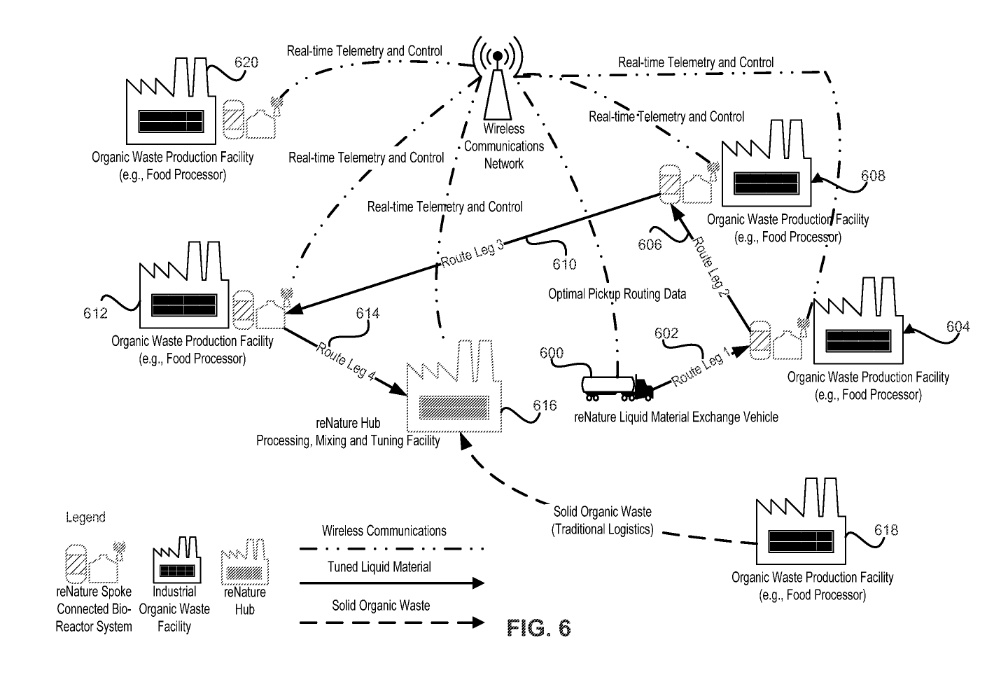

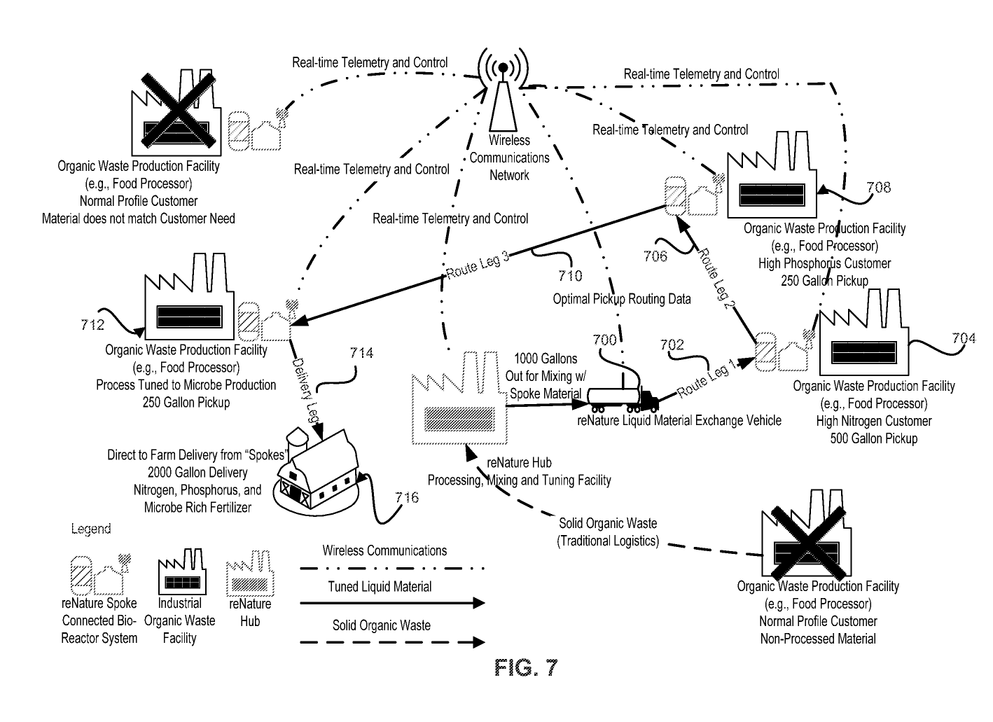

FIGS. 6 and 7 illustrate additional exemplary systems and methods in accordance with exemplary embodiments of the disclosures. In the example illustrated in FIG. 6, a pick-up truck 600 travels a first leg 602 to a first site 604 that includes a biodigestion reactor systems, such as a biodigestion reactor system described herein, travels a second leg 606 to a second site 608, including a biodigestion reactor system, a third leg 610 to a third site 612, including a biodigestion reactor system, and then a fourth leg 614 to a hub 616. Hub 616 can also receive material from an organic waste source 618 and/or other sites that include a biodigestion reactor. As illustrated in FIG. 6, one or more the of the sites 604, 608, 612, 616, 618, and 620 can transmit information (e.g., wirelessly to indicate information, as noted above, which can be used to indicate when material should be picked up or transferred to the various sites.

In the example illustrated in FIG. 7, material is picked up at various sites and transferred directly to a site for use. In the illustrated example, a truck 700 with product travels a first leg 702 to a first site 704 for additional material, with a relatively high nitrogen content, travels a second leg 706 to a second site 708 to pick up additional material with a relatively high phosphorous content, travels a third leg 710 to a third site for pickup of additional material with desired microbe composition, and travels a leg 714 to a site 716 for delivery of the nutrient-rich composition.

Optimization of routes travels by the pickup truck, such as trucks 600 and 700 can be calculated using a computer-implements system and/or instructions on a computer-readable medium.

In accordance with further exemplary embodiments of the disclosure, one or more method steps can be carried out using a computer-implemented system. One or more of the method steps can be implemented using instruction on a computer readable medium. By way of examples, a user can input soil test information and/or location information into a program that can then provide nutrient content for a nutrient-rich product. The nutrient-rich product can be custom tuned, e.g., as described herein, to provide a user with product suitable for his/her growing medium.

The subject matter of the present disclosure includes all novel and nonobvious combinations and subcombinations of the various systems, components, and configurations, and other features, functions, acts, and/or properties disclosed herein, as well as any and all equivalents thereof.

1. A method of producing nutrient-rich material from organic material, the method comprising the steps of:
providing a first biodigestion reactor for reacting one or more microorganisms with organic material to form one or more nutrient-rich products;
determining a desired concentration of one or more nutrients;
determining a concentration of the one or more nutrients in the first biodigestion reactor using one or more first reactor sensors; and
based on one or more of the desired concentration of one or more nutrients and the concentration of the one or more nutrients in the biodigestion reactor, selecting one or more available organic materials for feed to the first biodigestion reactor.

2. The method of producing nutrient-rich material from organic material of claim 1, further comprising the steps of:
providing a second biodigestion reactor fluidly coupled to the first biodigestion reactor; and
determining a concentration of the one or more nutrients in the second biodigestion reactor using one or more second reactor sensors.

3. The method of producing nutrient-rich material from organic material of claim 1, further comprising a step of sorting the organic material.

4. The method of producing nutrient-rich material from organic material of claim 1, further comprising a step providing a time estimate for collecting the organic material.

5. The method of producing nutrient-rich material from organic material of claim 4, wherein the step providing a time estimate is performed using a computer implemented system.

6. The method of producing nutrient-rich material from organic material of claim 1, wherein the first reactor sensors are selected from the group consisting of one or more of a temperature sensor, a pH sensor, an ethanol sensor, an H₂S sensor, an NH₃ sensor, a dissolved O₂ sensor, a weight sensor, and a nitrite sensor, CH₄ sensor.

7. The method of producing nutrient-rich material from organic material of claim 2, wherein the second reactor sensors are selected from the group consisting of one or more of a temperature sensor, a pH sensor, an ethanol sensor, an H₂S sensor, an NH₃ sensor, a dissolved O₂ sensor, a weight sensor, and a nitrite sensor, a CH₄ sensor.

8. The method of producing nutrient-rich material from organic material of claim 1, further comprising the steps of determining a distance to a source of organic material, wherein the step of selecting one or more of the available organic materials for feed to the biodigestion reactor is further determined using the distance.

9. The method of producing nutrient-rich material from organic material of claim 1, further comprising a step of monitoring an aerobic biodigestion reaction.

10. The method of producing nutrient-rich material from organic material of claim 9, further comprising a step of providing one or more of: sterilizing, adding material, and emptying a vessel based on the step of monitoring.

11. The method of producing nutrient-rich material from organic material of claim 9, wherein the step of monitoring is performed using one or more wireless sensors.

12. A method of producing nutrient-rich material from organic material, the method comprising the steps of:
providing a plurality of biodigestion reactor systems, each of the plurality of biodigestion reactor systems comprising a first biodigestion reactor for reacting one or more microorganisms with organic material to form one or more nutrient-rich products, and one or more first reactor sensors to provide an indicia of biodigestion;
determining one or more of an amount of organic material in the one or more of the plurality of biodigestion reactor systems, a stage of biodigestion in the one or more of the plurality of biodigestion reactor systems, and a concentration of nutrients in in the one or more of the plurality of biodigestion reactor systems; and
based on one or more of an amount of organic material, the stage of biodigestion, and the concentration of one or more nutrients, collecting product from one or more of the plurality of biodigestion reactor systems.

13. The method of producing nutrient-rich material from organic material of claim 12, further comprising a step of determining a distance to each of the plurality of biodigestion reactor systems.

14. The method of producing nutrient-rich material from organic material of claim 13, wherein the step of collecting is further based on the distance.

15. The method of producing nutrient-rich material from organic material of claim 12, wherein each of the plurality of biodigestion reactor systems comprises one or more of a temperature sensor, a pH sensor, an ethanol sensor, an H₂S sensor, an NH₃ sensor, a dissolved O₂ sensor, a weight sensor, a nitrite sensor, and a CH₄ sensor.

16. The method of producing nutrient-rich material from organic material of claim 12, further comprising a step of determining one or more of: type of one or microorganisms, a salinity, and a biomass of the one or more nutrient-rich products.

17. The method of producing nutrient-rich material from organic material of claim 12, further comprising a step of mixing one or more products from a first biodigestion reactor system with one or more products from a second biodigestion reactor system.

18. The method of producing nutrient-rich material from organic material of claim 17, wherein the step of mixing is based on one or more desired nutrient concentrations.

19. The method of producing nutrient-rich material from organic material of claim 12, wherein the step of determining a stage of biodigestion is performed using a wireless sensor.

20. The method of producing nutrient-rich material from organic material of claim 12, wherein the step of providing a plurality of biodigestion reactor systems further comprises providing a second biodigestion reactor.

21. (canceled)

22. (canceled)
